(19) United States
(12) Patent Application Publication
(10) Pub. No.: US 2026/0311895 A1
(43) Pub. Date: Oct. 8, 2026

(54) SYSTEM AND METHOD FOR FORMING INERTIAL CONFINEMENT FUSION TARGET CAPSULES WITH ENGINEERED FOAM INTERIOR SURFACES

(71) Applicant: Lawrence Livermore National Security, LLC, Livermore, CA (US)

(72) Inventors: Widianto Putra MOESTOPO, San Leandro, CA (US); Gregory Elijah KEMP, Tracy, CA (US); Nikola DUDUKOVIC, Hayward, CA (US); Kansas SEUNG, Stockton, CA (US); Xiaoxing XIA, Pleasanton, CA (US)

(21) Appl. No.: 19/710,544

(22) Filed: Jun. 17, 2026

Related U.S. Application Data
(63) Continuation-in-part of application No. PCT/US2025/059410, filed on Dec. 12, 2025.
Application No. PCT/US2025/059410 is a continuation of application No. 18/981,299, filed on Dec. 13, 2024.

(51) Int. Cl. G21B 1/19; B33Y 80/00; H05H 1/22; H05H 6/00

(52) U.S. Cl. CPC G21B 1/19; B33Y 80/00; H05H 1/22; H05H 6/00

(57) ABSTRACT

An additively manufactured target capsule is disclosed for containing a fuel to be used in an inertial confinement fusion operation. In some embodiments the target capsule has a spherical outer surface, an inner surface and a foam layer. The foam layer extends radially inwardly from the inner surface and is formed by a plurality of interconnected mesh layers. Each mesh layer is connected to an adjacent mesh layer by a plurality of engineered unit cells each having a plurality of interconnected elements, and follows a contour of the inner surface, and is susceptible to wetting with a liquid fuel.

### CROSS-REFERENCE TO RELATED APPLICATIONS

This application is a bypass continuation-in-part of International Application No. PCT/US2025/059410, filed Dec. 12, 2025; which claims the benefit and priority of U.S. patent application Ser. No. 18/981,299, filed Dec. 13, 2024. The disclosures of the above applications are incorporated herein by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to spherical target capsules used to contain fuel for inertial confinement fusion experiments, and more particularly to a spherical target capsule having an engineered interior foam surface.

### BACKGROUND

The statements in this section merely provide background information related to the present disclosure and may not constitute prior art.

State-of-the-art experimental methods to perform high energy density science (HEDS) research and inertial confinement fusion (“ICF”) require a laser system that directs its energy onto a target. Recent groundbreaking experiments have successfully demonstrated the first instances that fusion ignition (i.e., more energy generated via fusion reaction compared to the laser energy driven onto the target) can be achieved in a laboratory setting. These experiments relied on a deuterium-tritium (D-T) ice layer to be formed on the inner layer of the capsule. Manufacturing a capsule like this is a complex process that can take multiple months and the DT ice layering process alone can take days.

Researchers understand that a capsule that can hold a layer of liquid fuel on its inner surface would simplify target fabrication and allow the exploration of more complex phenomena, including higher ignition energy yield. Additive manufacturing (AM) techniques, in particular two-photon lithography (TPL), have been proposed to fabricate targets that would otherwise be impossible to manufacture using conventional means. TPL uses an optical objective to focus a femtosecond laser beam into a voxel inside a photoresist sensitive to light with a wavelength of approximately half of the laser beam wavelength. TPL has been used to fabricate low density (down to 30 mg/cm3 ) and low atomic-number (CHO) polymeric foams for potential targets, with some having been tested at the OMEGA Laser Facility at the University of Rochester. TPL has also been used to fabricate a capsule with a stochastic foam design, and a capsule with an attached foam layer outside of the solid shell.

Recently, the inventors of the present disclosure have shown a fully additively manufactured capsule with a foam layer inside the shell and a physical cutout to show the inner portion of the capsule (U.S. Ser. No. 18/981,299, filed Dec. 13, 2024). Previous inventions have not had specifically engineered foam designs that are uniform and which have generally repeatable unit cells in a cartesian coordinate, and such previously considered foam designs have not considered designs that would improve liquid fuel wetting and reduce hydrodynamic instabilities based on the foam design (see, e.g., U.S. Ser. No. 18/981,299).

Accordingly, a strong interest and need exists for further new capsule designs which enable wetting of an interior area of the capsule. Furthermore, a strong need exists for such capsules that can be manufactured rapidly, economically and with excellent uniformity and exceeding close dimensional tolerances.

### SUMMARY

This section provides a general summary of the disclosure, and is not a comprehensive disclosure of its full scope or all of its features.

In one aspect the present disclosure relates to an additively manufactured target capsule for containing a fuel to be used in an inertial confinement fusion operation. The target capsule may comprise a spherical outer surface, an inner surface and a foam layer. The foam layer extends radially inwardly from the inner surface, and is formed by a plurality of interconnected mesh layers. Each mesh layer is interconnected by a plurality of engineered unit cells each having a plurality of interconnected elements. Each mesh layer follows a contour of the inner surface, and the mesh layer is susceptible to wetting to hold a liquid fuel.

In another aspect the present disclosure relates to an additively manufactured target capsule for containing a fuel to be used in an inertial confinement fusion operation. The target capsule comprises a spherical outer mesh surface having an inner surface, and a foam layer extending radially inwardly from the inner surface. The foam layer is formed by a plurality of interconnected mesh layers, and each one of the interconnected mesh layers is connected to an adjacent one of the interconnected mesh layers by a plurality of engineered unit cells. Each one of the unit cells has a plurality of interconnected beams, and the foam layer is designed to enable being wetted with a liquid fuel.

In still another aspect the present disclosure relates to a method for forming a target capsule for containing a fuel to be used in an inertial confinement fusion operation. The method may comprise forming spherical outer shell with a first mesh layer, and then on an inner surface of the spherical outer shell, forming a foam layer extending radially inwardly from the inner surface. The foam layer is formed by a plurality of interconnected mesh layers, where adjacent ones of the mesh layers are connected by a plurality of engineered unit cells. The unit cells each have a plurality of interconnected elements. The foam layer is designed to enable being wetted with a liquid fuel, and the spherical outer shell and the foam layer are formed through an additive manufacturing operation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is an elevation view of a target capsule in accordance with one embodiment of the present disclosure;

FIG. 2 is a shows elevational side views of the target capsule of claim 1 with its perfectly spherical shape, and also that it may be formed instead with an oblong shape;

FIG. 3 is a shows a cross section the wall of the capsule to illustrate one example of the multi-layer foam construction of the wall;

FIG. 4 shows how unit cells may be used to interface two separate mesh layers together by using different faces of each unit cell, and also how beams that help form each unit cell may themselves be made up of smaller unit cells having the same or a different construction;

FIGS. 5-8 show examples of how the target capsule may be constructed using a triangle mesh structure, an icosahedron-based mesh structure, or virtually any other 2D polygonal mesh structure; the geodesic icosahedron-based mesh is uniquely suitable since it provides uniform partition of the spherical surface;

FIG. 9 shows how the vertices of the initial mesh structure being used to form the outermost layer of the target capsule may be adjusted radially and laterally to better follow a perfectly spherical contour; the beams connecting the vertices can also be curved to further follow a perfectly spherical contour;

FIG. 10 shows how different a unit cell may use one of its polygons to help form a first mesh layer, while a different polygon of the same unit cell is used to form a portion of a different mesh layer;

FIG. 11 shows examples of different designs of unit cells that may be used to help interface adjacent mesh layers to one another;

FIGS. 12 and 13 show further examples of different unit cell constructions;

FIG. 14 shows examples of different unit cell constructions incorporating one or more panels or curved surface between vertices and/or beams of the unit cells;

FIG. 15 shows examples of different unit cell constructions incorporation panels having different types of constructions, such as solid as well as a somewhat porous panel formed by shells; and

FIG. 16 shows further examples of how structural elements that may be used to form each unit cell may themselves be formed from smaller unit cells, and in some instances from triply periodic minimal surface structures.

### DETAILED DESCRIPTION

Example embodiments will now be described more fully with reference to the accompanying drawings.

The present disclosure relates to new foam design paradigm for ICF capsules and targets where one or more layers of three-dimensional meshes are included on an inner surface of an outer shell of a target capsule. If two or more layers of meshes are formed, then meshes may be connected to form a hierarchical engineered mesh structure that can be substantially or fully manufactured using additive manufacturing. In some embodiments the foam is connected (or “lined”) to, or integrally formed with the inner surface of the outer shell, and in one example application, the foam is either fully or partially wetted with liquid fusion fuel to hold the fuel in a certain predetermined shape. In some embodiments the foam is either fully or partially wetted with liquid fuel, which in some embodiments is a mixture of deuterium and tritium.

Referring to FIG. 1, one embodiment of an ICF target capsule 10 in accordance with the present disclosure is shown. The capsule 10 in this example makes use of an additively manufactured, bespoke, 3D foam mesh construction to form an engineered 3D sphere. Additive manufacturing (AM) enables foam geometry to be constructed for capsule targets which is even more complex, more precise and uniform, as compared to stochastic foam produced via traditional foam manufacturing methods. Producing a uniform foam-linear in spherical coordinate starts with a uniform spherical mesh that is used to infill the foam with bespoke unit cells made of structural elements that can exhibit structural hierarchy.

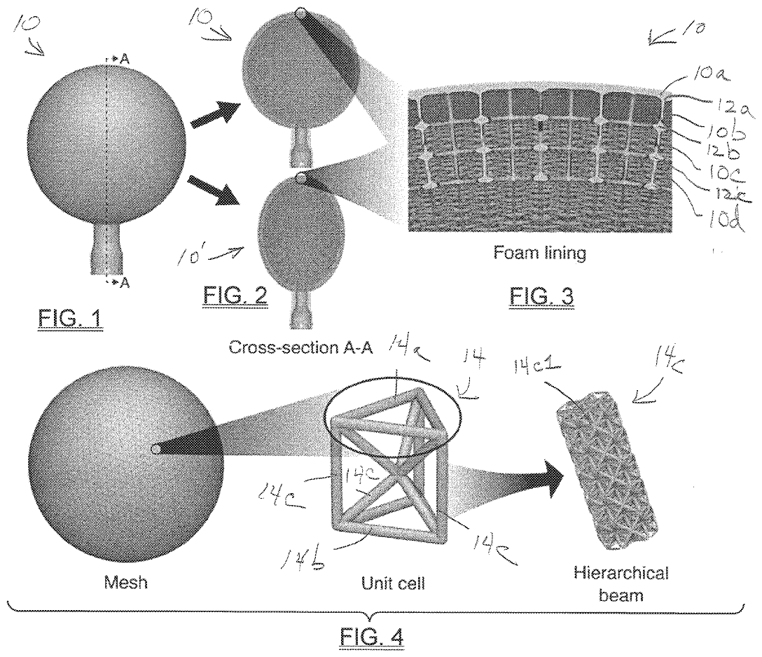

FIG. 2 illustrates slightly different constructions of the capsule 10, that is, the capsule having a perfectly spherical shape or optionally an oblong shape. The foam liner can be adjusted to fit the distorted shape. FIG. 3 illustrates one example of a multi-layer, engineered, 3D foam mesh construction for the capsule 10. The capsule 10 in this example has an outer shell 10a which forms a first mesh layer, a concentric second mesh layer 10b, a concentric third mesh layer 10c and a concentric fourth mesh layer 10d. A space 12a exists between the second mesh layer 10b and the first mesh layer 10a. A space 12b exists between the third mesh layer 10c and the second mesh layer 10b, and a space 12c exists between the third mesh layer 10c and the fourth mesh layer 10d. The spaces 12a, 12b and 12c forms interstitial spaces where beams or other elements can be 3D printed to attach the layers, and then the areas filled in with any desired form of unit cell (to be discussed in detail in the following paragraphs). Collectively, layers 10a-10d and interstitial spaces 12a-12c create an integrally formed multi-layer foam having a desired thickness and desired engineering properties which facilitate wetting and holding a liquid fuel. The layers 10a-10d may be constructed identically or they may differ from one another. Likewise, the interstitial spaces 12a-12c may be constructed identically or they may differ from one another. FIG. 3 is an example of how uniform unit cells can be created and distributed throughout the foam liner layer using such a construction method. This is different from previous foam designs that are based on periodic structures in a Cartesian coordinate system.

FIG. 4 illustrates that the interstitial spaces 12a-12c, as well as the layers 10a-10d, may be made up in whole or in part of a plurality of unit cells 14, where each unit cell forms a polygon. Each unit cell 14 in this example, has one triangle 14a formed by three interconnected elements, which forms one face of the unit cell and which is attached to one mesh structure (e.g., mesh layer 10b from FIG. 3). Another triangle 14b of the unit cell 14, formed by different interconnected elements, forms a second face of the unit cell 14 which is attached to a different mesh layer (e.g., mesh layer 10c from FIG. 3). So the opposite sides of the unit cell 14 present faces that form attachments and/or portions of two different, adjacent mesh layers. The two polygonal faces 14a and 14b can be connected with 3D elements, which in one form may be beams 14c, or optionally may be solid or porous plates, and/or optionally may be shells presenting a solid or porous surface. FIG. 4 also illustrates that each beam 14c may have a hierarchical structure, or put differently, may be made up of smaller unit cells of beams 14c1, and/or plates, and/or shells, or any combination thereof. These features can also be formed in connection with other 3D features to create additional, different hierarchical architectures for the beams 14c. So the beams 14c may be of identical construction or they may differ to impart a desired, engineered quality to the unit cell 14.

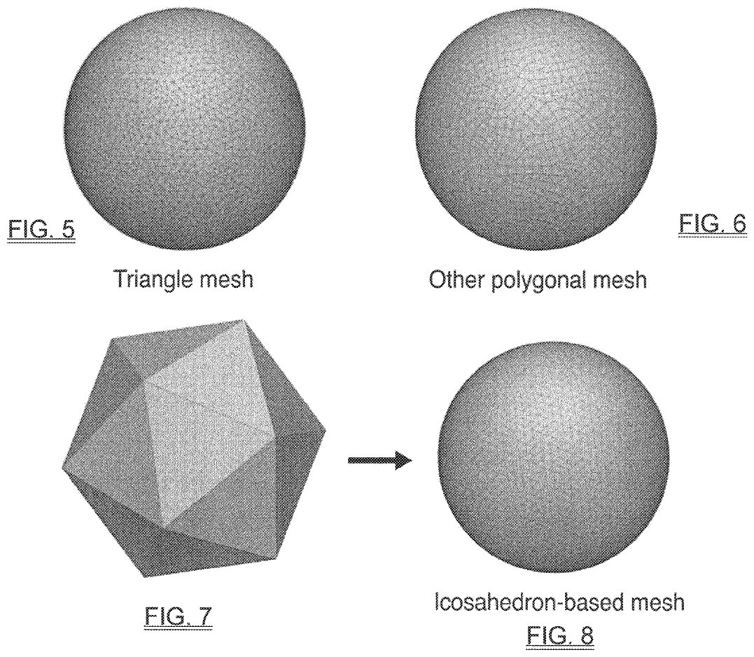

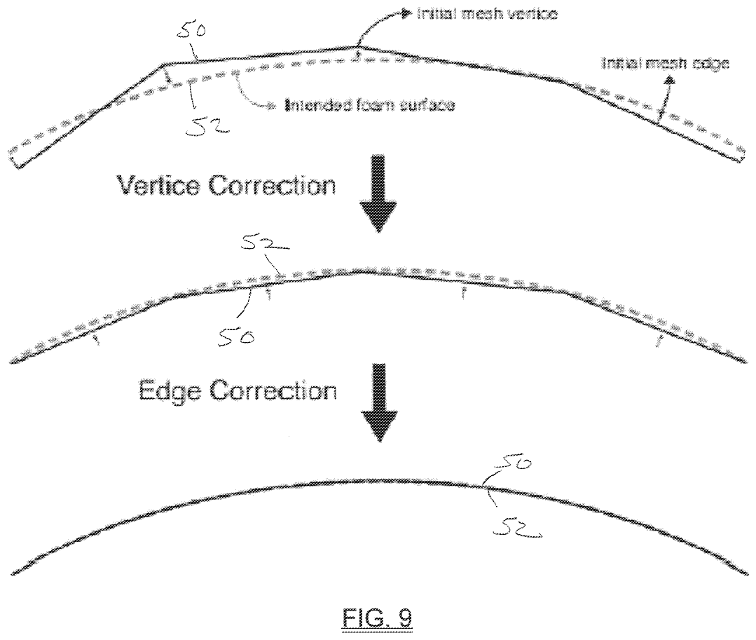

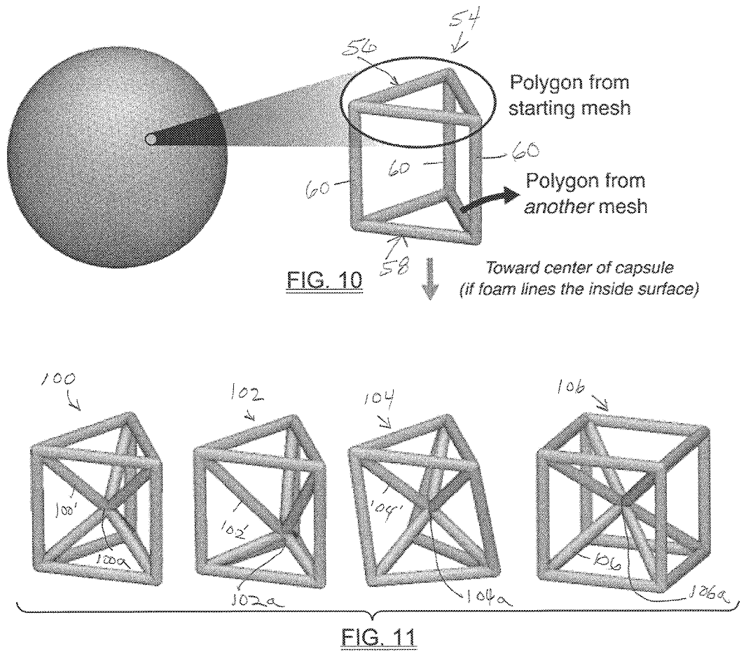

As shown in FIGS. 5-8, the starting surface mesh that forms the outermost layer of the capsule 10 can be generated in various ways, such as by using traditional meshing algorithm to produce a triangle mesh (FIG. 5) or other polygonal mesh (FIG. 6), as well as by starting with an icosahedron (FIG. 7) and refining it to a higher-order mesh, Icosahedron-based mesh (FIG. 8) to create a mesh of nearly uniform triangles. Whichever style mesh is utilized, the unit cells utilized are used in a manner to mesh the surface of a sphere as uniformly as possible. With the uniform meshes, the spherical foam liner can be subdivided into uniformly distributed interstitial spaces between mesh layers and unit cell structures can be created inside each interstitial space. This way a spherically uniform foam can be constructed, whereas previous foam designs are based on periodic unit cells in a Cartesian coordinate that introduce additional asymmetry during ICF implosion. In particular, the geodesic icosahedron-based mesh design produce highly radially symmetric foam liners that are experimentally tested at the National Ignition Facility.

Since traditionally generated meshes may have vertices that do not lay exactly on the intended surface geometry, the systems and methods of the present disclosure overcome this challenge by specifically correcting the location of each vertex. Each vertex is corrected such that it follows the intended surface geometry, as shown in FIG. 9. More specifically, each mesh edge is corrected such that it follows the curvature of the intended surface geometry. FIG. 9 shows the meshing uniformity of an icosahedron-based mesh 50 when combined with radial distance correction to create a perfectly spherical mesh that follows the desired contour of a sphere 52. Put differently, the meshing ligament 50 is selectively curved to match the curvature of the sphere 52.

With reference to FIG. 10, to form a unit cell whose design can be repeated throughout the entire foam, one embodiment of the present disclosure generates another surface mesh that is slightly smaller than the starting mesh, if the foam is intended to line the inner shell surface. Conversely, if an outer spherical foam surface is being formed, the outer surface could be larger than the innermost surface. As shown in FIG. 10, a simple unit cell 54 can be formed by connecting aligned vertices between two concentric meshes 56 and 58 with beams 60. In this example, one mesh (i.e., a mesh made up of polygons 58) is a scaled down version of the starting mesh (i.e., a mesh made up of polygons 56). Thus, a basic unit cell geometry is created by connecting faces of two concentric meshes, where each of the two concentric meshes have the same face shapes and number of vertices. FIG. 10 thus illustrates varying the basic unit cell design by (left-to-right): adding a node (node 100a) and more beams (100′) inside the unit cell 100, and placing the added node (102a) in an arbitrary, non-centrally located geometry), twisting one polygon mesh face with respect to the one across it (unit cell 104), and using meshes with a different polygonal shape (unit cell 106).

There are numerous iterations of unit cells that can be generated within this basic unit cell geometry. FIG. 11 shows different unit cell geometries 100, 102, 104 and 106 making use of beams 100′, 102′, 104′ and 106′, which interconnect at different spatial locations to forms nodes 100a, 102a, 104a and 106a, respectively, within each unit cell. FIG. 12 shows examples of unit cell designs 200, 202, 204 and 206 without structural members that are parallel to the capsule surface, and therefore the laser beam path in an inertial confinement fusion operation. Unit cells 200 and 202 include pyramidal structures 200a and 202a which are coupled at a single node 200b and 202b. Unit cells 204 include a plurality of rod-like structural elements 204a and 206a that are coupled at a single, centrally located node 204b and 206b, and where the structural elements 204a and 206a extend non-parallel to one another.

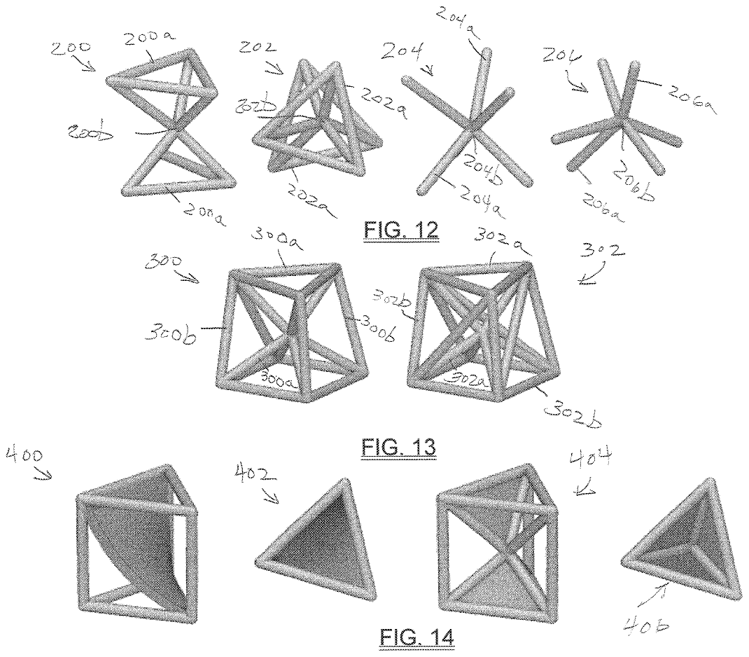

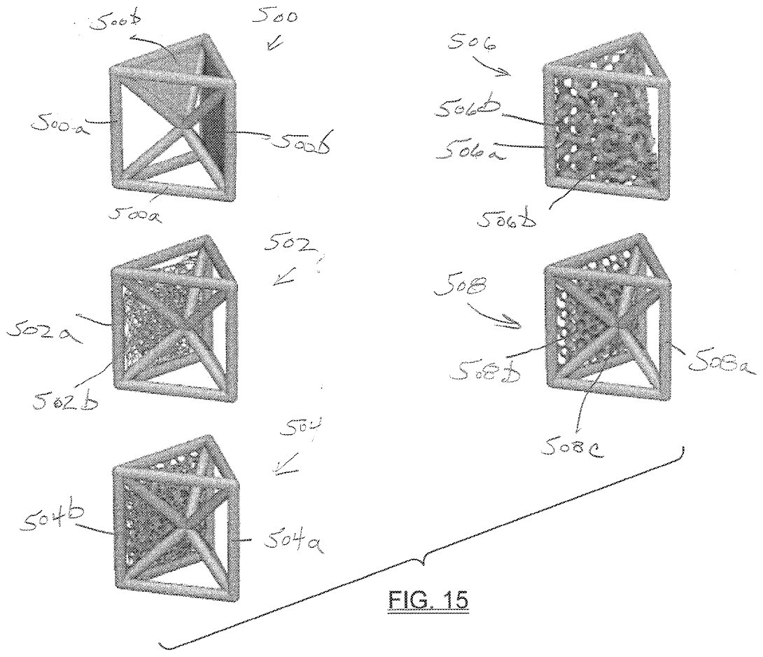

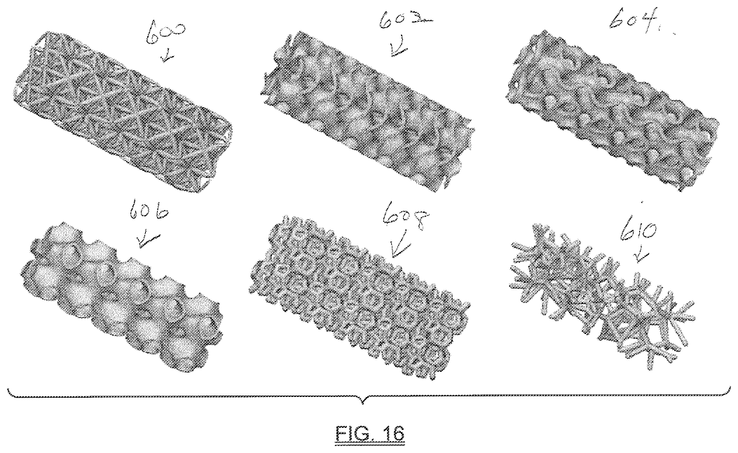

FIG. 13 shows unit cell designs 300 and 302 with meshes that have different polygonal shapes 300a and 300b, and 302a and 302b—in this example, triangle meshes (300a and 302a) and rectangle meshes (300b and 302b) which produce these unit cells. FIG. 14 shows further examples of unit cell designs 400, 402, 404 and 406 that present where beams can be replaced or augmented by panels and curved surfaces, which reduced direct line-of-sight blockage in the direction perpendicular to the mesh face, and therefore the laser beam path. FIG. 15 illustrates different unit cell designs 500-508 that each incorporate multiple different classes of structural members, such as beams, plates, and shells. Unit cell 500 is constructed from beams 500a and plates 500b. Unit cell 502 is constructed from beams 502a and porous shell panels 502b (i.e., panels made up of smaller interconnected shell-shaped elements). Unit cell 504 is constructed from beams 504a and a shell panel 504b. In this example porous shell panel 502b is a flat square, and shell panel 504b is a porous surface which forms a pyramid surface connected to the center vertices of the unit shell 504. Unit cell 506 is constructed of beams 506a and two perpendicular panels 506b, and without any centrally formed connecting node. Unit cell 508 is formed of beams 508a, a panel 508b and a central connecting node 508c. Aside from varying the thickness of a structural element within a unit cell, additional structural elements (e.g., additional beams as shown herein) can be added and removed from the initial unit cell geometry and the mesh faces that form the unit cell can also be transformed. These variations can improve the performance of the capsule target in a highly specific, engineered manner. For example, varying one or more physical variables such as the number of structural elements (e.g., beams), the cross-sectional size of each, the shape and/or overall geometry of a unit cell can introduce a lower energy barrier for liquid fuel wetting, reduce the amount of mass within a single laser beam path, prevent a direct line-of-sight of the laser to the center of the capsule, and increase overall capsule rigidity.

FIG. 16 shows further examples of beams 600-610 which can be used to form unit cells. The beams 600-610 each incorporate structural elements that can each be formed by smaller structural elements, thus creating a hierarchical design. In some examples, for example at least beam 606, the beam maybe formed by a triply periodic minimal surface.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An additively manufactured target capsule for containing a fuel to be used in an inertial confinement fusion operation, the target capsule comprising:
a spherical outer surface;
an inner surface;
a foam layer extending radially inwardly from the inner surface, the foam layer being formed by a plurality of interconnected mesh layers, where each said mesh layer is interconnected by a plurality of engineered unit cells each having a plurality of interconnected elements, and where each said mesh layer follows a contour of the inner surface, and where the mesh layer is susceptible to wetting to hold a liquid fuel.

2. The target capsule of claim 1, wherein at least a subplurality of the unit cells are formed with a polygon shape.

3. The target capsule of claim 1, wherein each of the unit cells are formed from a combination of triangles or squares connected at vertices thereof by beams, and wherein the triangles or squares and their respective beams are not parallel to the outer surface of the target capsule, and thereof not parallel to a path of a laser beam path used in an inertial confinement fusion operation.

4. The target capsule of claim 2, wherein the polygon shape comprises a pair of triangles coupled at their respective vertices by elongated beams.

5. The target capsule of claim 3, wherein the polygon shape comprises a pair of triangles coupled to one another by a plurality of beams that also intersect at a point within an interior volume of the unit cell.

6. The target capsule of claim 4, wherein the plurality of beams connects the pair of triangles such that the triangles are not co-planar with one another.

7. The target capsule of claim 1, wherein the polygon shape comprises a pair of squares connected at vertices thereof by at least four beams.

8. The target capsule of claim 7, wherein the pair of squares are further connected by additional beams that interconnect to form a node within an interior volume of the unit cell.

9. The target capsule of 2, wherein the polygon shape comprises a combination of at least one triangle and at least one square coupled at vertices thereof by a plurality of beams.

10. The target capsule of claim 2, wherein the polygon shape comprises a pair of triangles connected at vertices thereof by a plurality of beams, and at least one panel extending between a plurality of the vertices of the unit cell.

11. The target capsule of claim 2, wherein the polygon shape comprises pair of at least one of triangles or squares, connected at vertices thereof by a plurality of beams, and at least one panel constructed of shells to form a non-solid surface, extending between a subplurality of the vertices.

12. The target capsule of claim 1, wherein each said mesh layer has a plurality of vertices, and wherein the vertices are aligned to follow a contour of a sphere.

13. The target capsule of claim 1, wherein the unit cells are parallel to the capsule surface, and therefore to a beam path of a laser beam being used in an inertial confinement fusion operation.

14. The target capsule of claim 1, wherein the unit cells each include a plurality of three dimensional pyramidal structures coupled together at vertices thereof.

15. The target capsule of claim 1, wherein the unit cells include a plurality of structural elements connected at a centrally located node, and extending non-parallel to one another.

16. An additively manufactured target capsule for containing a fuel to be used in an inertial confinement fusion operation, the target capsule comprising:
a spherical outer mesh surface;
the spherical outer mesh surface having an inner surface;
a foam layer extending radially inwardly from the inner surface, the foam layer being formed by a plurality of interconnected mesh layers, where each one of said interconnected mesh layers is connected to an adjacent one of said interconnected mesh layers by a plurality of engineered unit cells; and
wherein each one of said unit cells has a plurality of interconnected beams, and where the foam layer is designed to enable being wetted with a liquid fuel.

17. The target capsule of claim 16, wherein at least a subplurality of the unit cells are formed with a polygon shape having a plurality of interconnected beams connected to form a plurality of vertices, and wherein:
a first portion of each one of said subplurality of unit cells forms a portion of one of said interconnected mesh layers, and
a second portion of each one of said subplurality of unit cells forms a portion of a different one of said interconnected mesh layers.

18. The target capsule of claim 17, wherein the unit cells include at least one of:
a solid panel extending between a plurality of the vertices of the unit cell; and
a porous panel extending between a plurality of the vertices of the unit cell.

19. A method for forming a target capsule for containing a fuel to be used in an inertial confinement fusion operation, the method comprising:
forming spherical outer shell with a first mesh layer;
on an inner surface of the spherical outer shell, forming a foam layer extending radially inwardly from the inner surface, the foam layer being formed by a plurality of interconnected mesh layers, where adjacent ones of said mesh layers are connected by a plurality of engineered unit cells each having a plurality of interconnected elements, and where the foam layer is designed to enable being wetted with a liquid fuel; and
wherein the spherical outer shell and the foam layer are formed through an additive manufacturing operation.

20. The method of claim 19, wherein the unit cells interconnecting interconnected mesh layers form polygons each have a plurality of faces, with the faces being used to form portions of adjacent ones of the interconnected mesh layers.
